(19) United States
(12) Patent Application Publication
(10) Pub. No.: US 2024/0111852 A1
(43) Pub. Date: Apr. 4, 2024

(54) METHOD AND SYSTEM FOR GENERATING A VIRTUAL AUTHENTICATOR

(71) Applicant: Konica Minolta Business Solutions U.S.A., Inc., Ramsey, NJ (US)

(72) Inventors: Subramanyam BADRI, Livermore, CA (US); Randy Cruz SORIANO, San Leandro, CA (US)

(73) Assignee: Konica Minolta Business Solutions U.S.A., Inc., Ramsey, NJ (US)

(21) Appl. No.: 17/957,325

(22) Filed: Sep. 30, 2022

(51) Int. Cl. G06F 21/33

(52) U.S. Cl. CPC G06F 21/33

(57) ABSTRACT

A method, a system, and a non-transitory computer readable program code are disclosed for generating a virtual authenticator for access to relying party applications hosted by a service provider. The method includes receiving, by a processor, authentication information from an authenticator device for a user with a request for access to one or more relying party applications hosted by the service provider; identifying, by the processor, a virtual authenticator profile for the user based on the authentication information received from the authenticator device; and generating, by the processor, an authentication token for the user based on the virtual authenticator profile for the user and in accordance with an authentication method of the service provider.

### FIELD

The present disclosure relates to a method and system for generating a virtual authenticator for access to a service provider, and more particularly, for example, a method and system for generating a virtual authenticator for access to a service provider, for example, from a multi-function peripheral (MFP).

### BACKGROUND

Single sign-on (SSO) is an authentication process that allows a user to access multiple applications with one set of login credentials. Single sign-on, for example, is a common procedure in enterprises, where a client accesses multiple resources connected to a local area network (LAN).

Single sign-on (SSO) can be performed using an identity provider (IdP or IDP), which can be a system entity that creates, maintains, and manages identity information for principals and provides authentication services to relying applications within a federation or distributed network. Identity providers (IdP) offer user authentication as a service. Service providers or relying party applications, such as web applications, can outsource the user authentication step to a trusted identity provider. Such a service provider or relying party application can be said to be federated, that is, it consumes federated identity.

An identity provider can be, for example, a trusted provider that allows a system to use single sign-on (SSO) to access other websites. In addition, single sign-on (SSO) can enhance usability, for example, by reducing the number of passwords that a user needs to recall to access a plurality of web applications. In addition, an identity provider (IdP) can provide security and can also facilitate connections between cloud computing resources and users that can decrease the need for users to re-authenticate when using mobile and roaming applications.

Service provider offers various methods to authenticate users. For example, the authentication method (or authenticator) can be using user ID and password, smart card, biometric like fingerprint or using mobile device as authenticator, etc. However, each of the authentication methods has its own separate process of authenticating user. For example, the authentication method can be as simple as inputting the user ID and password credentials, or a smart card that can generate and store user public credentials with cryptographic keys, etc. In addition, each of the authentication methods has a separate authentication path when supported by the service provider. Accordingly, adding a new authentication method into the service provider often requires the service provider to continuously provide a system update to accommodate a new authentication method.

### SUMMARY

Accordingly, it would be desirable to have a method and system for generating a virtual authenticator for access to a service provider, and more particularly, for example, a method and system for generating a virtual authenticator for access to a service provider, for example, from a multi-function peripheral (MFP), and wherein the method and system can supports a plurality of authentication methods, which may not all be supported by the service provider.

In accordance with an embodiment, a method is disclosed for generating a virtual authenticator for access to relying party applications hosted by a service provider, the method comprising: receiving, by a processor, authentication information from an authenticator device for a user with a request for access to one or more relying party applications hosted by the service provider; identifying, by the processor, a virtual authenticator profile for the user based on the authentication information received from the authenticator device; and generating, by the processor, an authentication token for the user based on the virtual authenticator profile for the user and in accordance with an authentication method of the service provider.

In accordance with an embodiment, a computer program product is disclosed for generating a virtual authenticator for access to relying party applications hosted by a service provider, the computer program product comprising: a non-transitory computer-readable storage medium having program instructions embodied therewith, the program instructions executable by a computer to cause the computer to perform a process, comprising: receiving authentication information from an authenticator device for a user with a request for access to one or more relying party applications hosted by the service provider; identifying a virtual authenticator profile for the user based on the authentication information received from the authenticator device; and generating an authentication token for the user based on the virtual authenticator profile for the user and in accordance with an authentication method of the service provider.

In accordance with an embodiment, a system for generating a virtual authenticator for access to relying party applications hosted by a service provider, the system comprising: a processor configured to: receive authentication information from an authenticator device for a user with a request for access to one or more relying party applications hosted by the service provider; identify a virtual authenticator profile for the user based on the authentication information received from the authenticator device; and generate an authentication token for the user based on the virtual authenticator profile for the user and in accordance with an authentication method of the service provider.

It is to be understood that both the foregoing general description and the following detailed description are exemplary and explanatory and are intended to provide further explanation of the invention as claimed.

### BRIEF DESCRIPTION OF THE DRAWINGS

FIG. 1 is an illustration of a system for user authentication with one or more authenticators, which are supported by a service provider in accordance with an embodiment.

FIG. 2 is an illustration of a system for user authentication with a virtual identifier generated from one or more authenticators in accordance with an embodiment.

FIGS. 3A and 3B are illustrations of a flowchart for generating a virtual authenticator from one or more authenticators in accordance with an embodiment.

FIG. 4 is an illustration of a plurality of scenarios for generating a virtual authenticator for a user in accordance with an embodiment.

FIG. 5 is an illustration of a flowchart for generating a virtual authenticator for access to relying party applications hosted by a service provider in accordance with an embodiment.

FIG. 6 is an illustration of an exemplary hardware architecture for an embodiment of a computer system.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

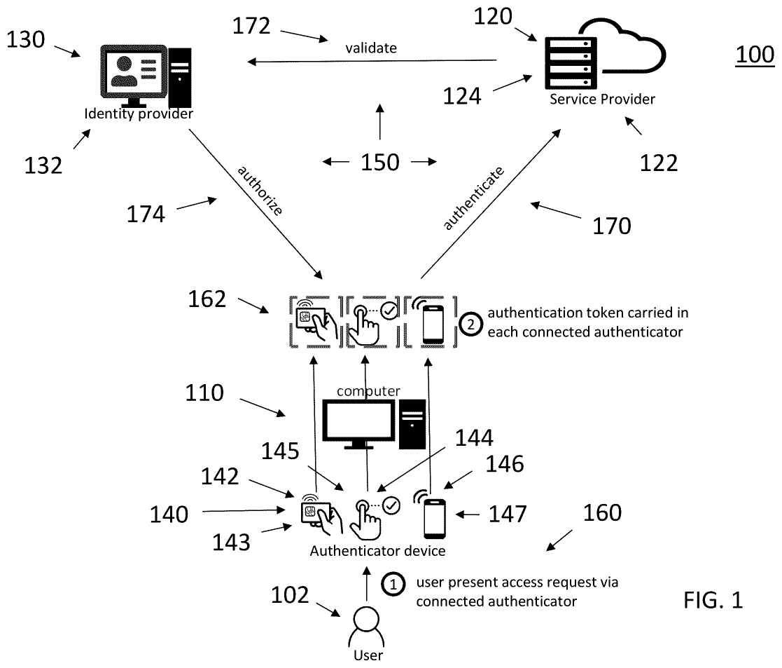

FIG. 1 is an illustration of a system 100 for user authentication with one or more authenticators, which are supported by a service provider 122 in accordance with an embodiment. As shown in FIG. 1, the system 100 can include, for example, one or more computer systems 110, 120, 130. The one or more computer systems 110, 120, 130 can be, for example, a personal computer, a home or office security system within a home or office, a server, a smart phone, a smart tablet, a camera, a router, a medical device or apparatus, a multi-function peripheral MFP (or printer), that can generate print data usable in a printer, or a print server, and the like. The system 100 can also include one or more authenticator devices 140. The one or more authenticator devices 140 can include one or more of, for example, a smart card authenticator (or smart card reader) 142, a biometric authenticator (or biometric reader) 144, and a smart phone authenticator (or smart phone reader) 146. The authenticator device 140 can also be a keyboard associated with the computer system 110, which is configured to receive a user identifier (ID) and password, for example.

The one or more computer systems 110, 120, 130 can include a processor or central processing unit (CPU), and one or more memories for storing software programs and data. The processor or CPU carries out the instructions of a computer program, which operates and/or controls at least a portion of the functionality of the devices the one or more computer systems 110, 120, 130. The one or more computer systems 110, 120, 130 can also include an operating system (OS), which manages the computer hardware and provides common services for efficient execution of various software programs. For example, the software programs can include application software, for example, for managing an authentication module and/or biometric identifier, and/or printer driver software, for example, for one or more of the computer systems 110, 120, 130, for example, the computer system 110.

The computer system 110 can be a multi-function peripheral (MFP) or printer, which can be connected to the computer systems 120, 130 via a communications network 150. The multi-function peripheral (MFP) can include at least a copy function, an image reading function, a facsimile (fax) function, and a printer function, and forms an image on a sheet based on a print job multi-function peripheral (print instruction) received, for example, from the computer system 110.

For example, the computer system 110 can be a medical device or a medical apparatus, which can be used, for example, for diagnostic and/or therapeutic purposes. Examples of medical devices or medical apparatuses can include medical imaging devices, which can obtain, for example, radiological, angiographic, sonographic, and/or tomographic images. Alternatively, the one or more computer systems 110, 120, 130, for example, the computer system 130 can be, for example, a back-end database, or enterprise database system, which can be accessed by the one or more users indirectly through an external application, for example, through the one or more computer systems 110, 120.

As shown in FIG. 1, the system 100 can be used for online authentication of a user 102 in accordance with an authentication method for access to one or more relying party applications 122, for example, one or more web applications hosted on the computer system 120. The one or more relying party applications 122 can include, for example, web applications, such as Google Workspace (previously G Suite), Salesforce, Microsoft365, and Box.

In accordance with an embodiment, when the computer system 110 is a multi-function peripheral (MFP) or printer, the one or more relying party applications can be, for example, for print management services. The print management services can include, for example, one or more of user authentication, monitoring and reporting, user and cost management, cost accounting and budget management, printer queue management, and workflow management. For example, user authentication can include control over identities of user, which can help ensure that users have been authenticated at a device before a print job is released and/or printed. The monitoring and report features can allow administrators to track and monitor usage in real time through regular, scheduled and on-demand reporting. The user and cost management feature can help manage and charge back costs by assigning users to cost centers, or enabling them to select the relevant cost center, billing or project code before printing a document. In addition, the user and cost management feature can be used to create print rules or policies, which can help ensure tighter cost management by allowing different user roles to access different devices and features. For example, the user and cost management feature can control, for example, duplex printing and/or color printing to individuals and/or groups. In addition, cost accounting and budget management provides for cost control and flexibility, which can be used as a print management solution that allows administrators to assign print budgets to users, with the option to top up their accounts. For example, in an environment such as a university, for example, this allows administrators to give students a free print quota that they can add to as required. In addition, a print queue management can be used for manage of individual production in addition to office print queues in an office, for example.

The one or more computer systems 110, 120, 130 can be connected via a communication network 150. The communication network 150 may include, for example, a conventional type network, wired or wireless, and may have any number of configurations, such as a star configuration, token ring configuration, or other known configurations. The communication network 150 may include one or more local area networks (“LANs”), wide area networks (“WANs”) (e.g., the Internet), virtual private networks (“VPNs”), peer-to-peer networks, near-field networks (e.g., Bluetooth®), cellular networks (for example, 3G, 4G, 5G, other generations), and/or any other interconnected data path across which multiple computing nodes may communicate.

Data may be transmitted in encrypted or unencrypted form between the one or more computer systems 110, 120, 130 using a variety of different communication protocols including, for example, various Internet layer, transport layer, or application layer protocols. For example, data may be transmitted between the one or more computer systems 110, 120, 130 via the network 150 using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), file transfer protocol (FTP), WebSocket (WS), wireless access protocol (WAP), various messaging protocols (SMS, MMS, XMS, IMAP, SMTP, POP, WebDAV, etc.), or other known protocols.

As shown in FIG. 1, the user 102 can present an access request 160 via one or more authenticator devices 140 that is connected to the computer system 110. The access request 160 can be for one or more replying applications 124 hosted on the computer system 120 of the service provider 122. In accordance with an embodiment, the one or more authenticator devices 140 can be configured to receive the authenticator(s) and/or biometric identifier(s), for example, via a keypad for a username and password (“password”), and/or a sensor, scanning device, or an electronic reader, which can read and/or obtain data from, for example, a proximity cards, a radio-frequency identification (RFID) card, smart cards, wearable devices, RSA tokens, and/or biometric identifiers. In accordance with an embodiment, the one or more authenticator devices 140 can be an authenticator, for example, a physical authenticator 142, 144, 146, that can be one or more of a physical electronic authorization device, for example, a smart card authenticator (or smart card reader) 142, configured to authenticate a smart card 143, a biometric authenticator (or biometric reader) 144 configured to authenticate a biometric 145, for example, a fingerprint of the user 102, and a mobile device authenticator (or mobile device reader) 146 configured to authenticate a mobile device 147. For example, authentication via the mobile device authenticator 146 can include the presentation of the mobile device 147 of the user 102 to a vicinity of the authenticator device 140 via a near-field networks (e.g., Bluetooth®) and wherein the user 102 has previously been authenticated on the mobile device 147 by one or more of a user identifier (ID) and password and/or a biometric identifier, for example, facial recognition, fingerprint, of the like.

In accordance with an exemplary embodiment, the biometric authenticator (or authenticator reader) 144 can be identify a biometric 145, which is a distinctive, measurable characteristics used to label and describe or identify an individual, including a metric related to human characteristics. For example, the biometric 145 can include physiological characteristics of an individual including but not limited fingerprints, palm veins, face recognition, DNA (or deoxyribonucleic acid), palm print, hand geometry, iris recognition, retina, and/or odor/scent.

In accordance with an embodiment, once the user 102 has been authenticated via one or the one or more authenticator devices 140 associated with the computer system 110, the computer system 110 can issue an authentication token carried or hosted in each of the connected one or more authenticator 142, 144, 146. For example, the authentication token 162 can be issued by the smart card authenticator 142 upon the presentation of the smart card 143, the detection of a biometric 145 on the biometric authenticator 144, or the mobile device 147 to the mobile device authenticator 146. As shown in FIG. 1, each of the one or more authenticator devices 140 will issue an authentication token 162 that is carried in each of the connected authenticator devices 150, i.e., the issued authentication token 162 will correspond to the authentication method, which is supported by the service provider 122. For example, the service provider 122 may only support one authentication method, for example, a smart card 143, and the computer system 110 may not be able to generate an authentication token 162 for the user 102 with a smart card reader 142.

Once the authentication token 162 has been issued, the computer system 110 can then request access (170) to one or more reply party applications 124, for example, one or more web applications, hosted on the computer system 120 by sending authentication token 162 carried in each connected authenticator 142, 144, 146, for the user 102. The computer system 120 of the service provider 122 receives the authentication token 162 for the user 102 and sends the authentication token 162 to the computer system 130 of an identify provider 132, which can authenticate the authentication token 162.

As shown in FIG. 1, the computer system 130 can be an identity provider (IdP) 132 configured to store and manage digital identities of one or more users 102. The identity provider (IdP) 132 can check the authentication token 162 for the user and if the authentication token is valid, the identity provider 132 can authorize 170 the user 102 to access one or more replying party applications 124 being hosted the computer system 120 of the service provider 122. In accordance with an embodiment, the one or more replying party applications 124 can be, for example, print management services for the computer system 110 in the form of a multi-functional peripheral (MFP).

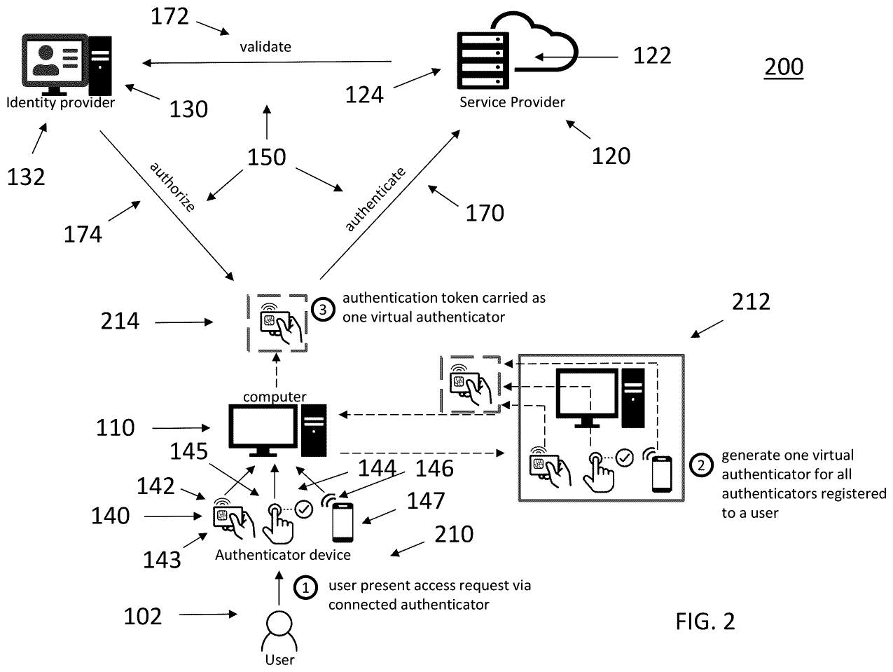

FIG. 2 is an illustration of a system 200 for user authentication with a virtual identifier generated from one or more authenticators in accordance with an embodiment. As shown in FIG. 2, the system 200 includes an authentication method that can be used in place of several authentication methods and separate authentication paths. The one authentication method is generated as a virtual authenticator and assigned to the several authentication method. For example, if the service provider 122 only has smart card authentication method, the system 200 can generate a virtual ID following the smart card authentication method. The smart card will be assigned to the generated virtual ID, which can help expand the system 200 to support, for example, a biometric such as a fingerprint, and wherein the fingerprint is converted following the smart card authentication method and assigned to the same generated virtual ID as disclosed herein.

As shown in FIG. 2, the system 200 includes an authentication method that can be used in place of a plurality of authentication methods and a separate authentication path. In accordance with an exemplary embodiment, the one authentication method is generated as a virtual authenticator and can be assign to a plurality of authentication method. For example, the service provider 120 may accept only one authentication method, for example, the one or more reply party applications 124 may be print services, and the service provider 120 may only be configured to receive access request with smart card authentication 143. However, it may be desirable to provide users 102 with one or more options to obtain access to the services provided by the service provider via one or more different authenticator devices 140, for example, via a biometric 145 or a smart phone device 147.

In accordance with an embodiment, if the service provider 120 accepts only one authentication method, for example, a smart card authentication method, the system 200 as disclosed herein, can generate a virtual authenticator 212 that has the properties of a smart card authentication without regard to the authentication method. For example, as shown in FIG. 2, the user 102 can present one or more of a smart card 143 to a smart card reader 142, a biometric 145 to a biometric reader 144, or a smart phone 147 to smart phone reader 146 with an access request 210 via the authenticator (or reader) 142, 144, 146, which is connected to the computer system 110. The computer system 110 can be configured to generate a virtual authenticator 212 (i.e., one virtual authenticator) for one or more of the plurality of authenticators registered to a user 102. The virtual authenticator 212 can be used to generate an authentication token 214 carried as one virtual authenticator that can be presented to the service provider 120 for authenticator and access to the one or more service or replying applications 124 hosted by the computer system 120 of the service provider 120. Accordingly, when the service provider 120 only accepts certain authenticators or authentication methods, the system 200 can generate the virtual authenticator 212 and the corresponding authentication token 214 carried as one virtual authenticator without regard to the authentication method. For example, if the service provider 120 utilizes a smart card authentication for providing services 124, the system 200 can generate the authentication token 214 carried as one virtual authenticator 212 following a biometric authentication method of the user 102, for example, a fingerprint of the user 102.

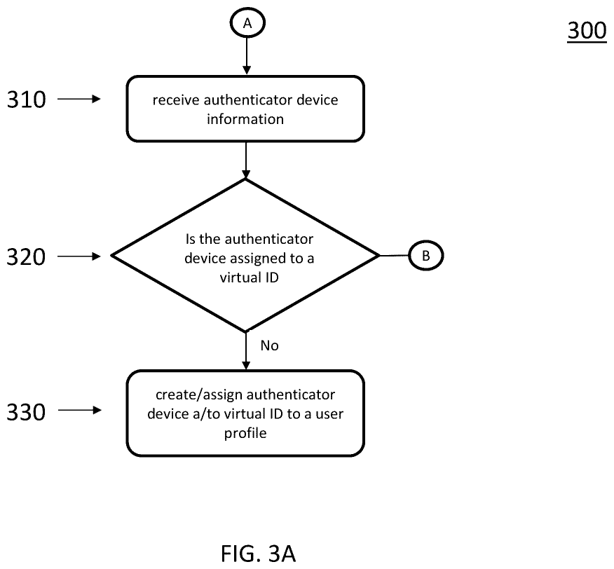

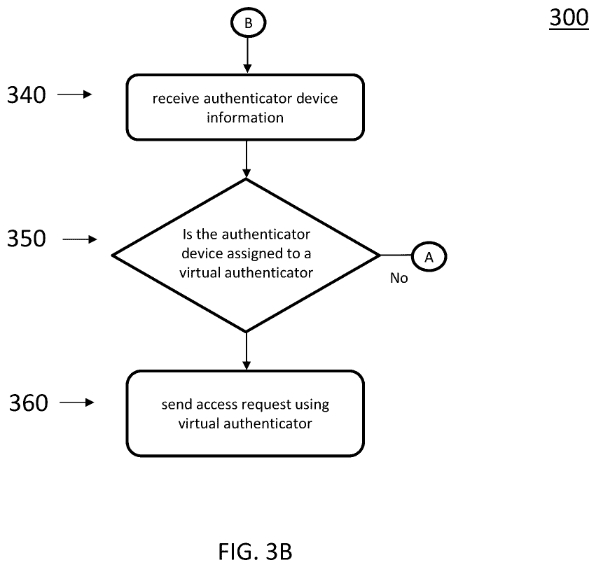

FIGS. 3A and 3B are illustrations of a flowchart 300 for generating a virtual authenticator 212 from one or more authentication methods in accordance with an embodiment. As shown in FIG. 3, system 200 in step 310 receives authentication device information from one or more authenticator devices 140. The system 200 determines in step 320, if the authentication device information corresponds to an authenticator device 140 that has been assigned to a virtual authenticator profile (i.e., virtual identifier (ID)) for the user 102. If the authentication device information is not assigned to a virtual authenticator profile (or virtual ID), the process continues to step 330 in which the system 200 creates and assigns the authenticator device 140 to a virtual authenticator profile (or a virtual ID) to a user profile. If the authentication device is assigned to a virtual ID, the process continues to step 340 in which the system 200 receives the authentication device information. In step 350, the system 200 determines if the authenticator device 140 is assigned to a virtual authenticator 212. If the authenticator device 140 is assigned to a virtual authenticator 212, the process continues to step 360 in which the system 200 sends an access request to the service provider 122 with the virtual authenticator 214. If the authenticator device is not assigned to a virtual authenticator 214 in step 350, the process returns to step 310 to create and/or assign the authenticator device 140 to a virtual authenticator 214 as disclosed herein.

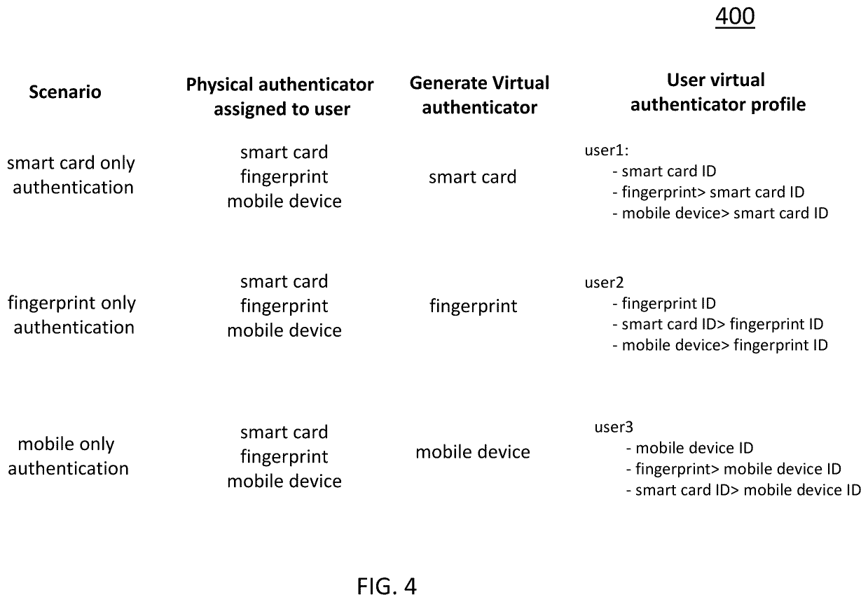

FIG. 4 is an illustration of a plurality of scenarios 400 for generating a virtual authenticator for a user in accordance with an embodiment. As illustrated in FIG. 4, the plurality of scenarios 400 can include one or more of the authentication methods for the service provider 122 being one or more of smart card only authentication, fingerprint (or biometric) only authentication, and mobile device only authentication. For example, the physical authenticators assigned to each of the one or more users 102 can include smart card, fingerprint (biometric) and mobile device. In accordance with an embodiment, the system and method as disclosed herein can be configured to generate one or more of a virtual authenticator 214, for example, for a smart card, a fingerprint (biometric), and a mobile device. For example, under the scenario in which the service provider 122 accepts only smart card authentication (i.e., a smart card authentication method), the system 200 can generate a virtual authenticator 214 (smart card ID) for the user 102 that complies with the smart card authentication method of the service provider 102 by generating a virtual authenticator profile, for example, for the user 102 (i.e., user1) which includes a smart card identifier (ID), a fingerprint (or biometric), which can be converted into a smart card identifier (ID), and mobile device, which can be converted into the smart card ID. Alternatively, if the service provider 122 only accepts fingerprint (or biometric) authenticators, the generated virtual authenticator can be fingerprint in which the user 102 (i.e., user2) identifies a fingerprint of the user 102, converts a smart card ID into the fingerprint (biometric) ID, and converts a mobile device ID into the fingerprint (biometric) ID. In another embodiment, if the service provider 122 is a mobile device only authentication method, the system 200 can be configured to generate a virtual authenticator for the mobile device ID for a user 102 (e.g. user3) by identifying a mobile device ID, converting a fingerprint (or biometric) ID into a mobile device ID, or converting a smart card ID into the mobile device ID.

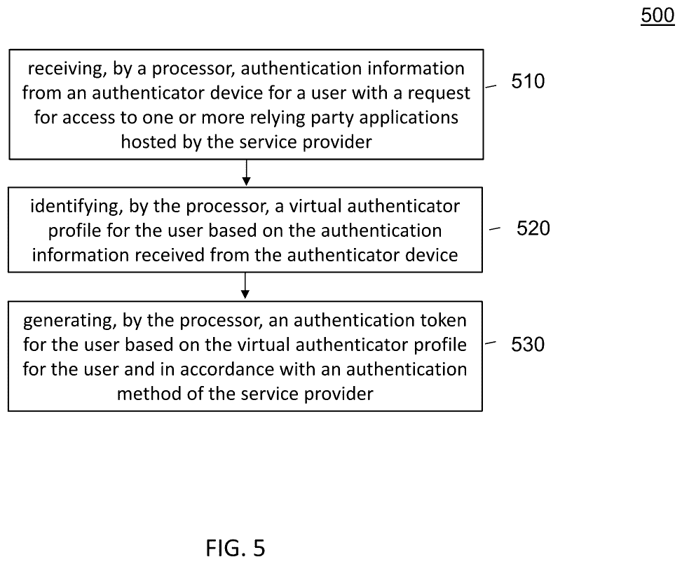

FIG. 5 is an illustration of a flowchart for generating a virtual authenticator 500 for access to relying party applications hosted by a service provider 122. The method 400 can include receiving, by a processor, authentication information from an authenticator device 140 for a user 102 with a request for access to one or more relying party applications 124 hosted by the service provider 122 (502), identifying, by the processor, a virtual authenticator profile for the user 102 based on the authentication information received from the authenticator device 140 (504); and generating, by the processor, an authentication token 214 for the user based on the virtual authenticator profile for the user and in accordance with an authentication method of the service provider (506). In accordance with an embodiment, the method 500 further includes generating, by the processor, a virtual authenticator 212 for the user 102 based on the virtual authenticator profile for the user 102 and the authentication method of the service provider 122; and generating, by the processor, the authentication token 214 for the user 102 with the virtual authenticator 212.

In accordance with an embodiment, the method 500 further includes determining, by the processor, the authentication method for the service provider 122; and sending, by the processor, the authentication token 214 for the user 102 in accordance with the authentication method of the service provider 122 with the request for access to the one or more relying party applications 124 to the service provider 122.

In accordance with an embodiment, the method 500 further includes receiving, by the processor, the authentication information from the authenticator device 140; determining, by the processor, that the received authentication information from the authenticator device 140 is a different authentication method than the authentication method of the service provider 122; and generating, by the processor, the authentication token 214 for the user in accordance with the authentication method of the service provider 122.

In accordance with an embodiment, the method further includes receiving, by the processor, the authentication information from the authenticator device 140 in a first authentication method; determining, by the processor, that the received authentication information from the authenticator device 140 is the authentication method of the service provider 122; and generating, by the processor, the authentication token 214 for the user in accordance with the authentication method of the service provider 122.

In accordance with an embodiment, the method further includes assigning, by the processor, a plurality of physical authenticators to the user 102; receiving, by the processor, one of the plurality of physical authenticators for the user from the authenticator device 140; and identifying, by the processor, the virtual authenticator profile for the user 122 based on the one of the plurality of physical authenticators for the user received from the authenticator device 140. The method 500 also includes receiving, by the processor, the authentication information from the authenticator device 140 for the user 102 with the request for the access to the one or more relying party applications 124 hosted by the service provider 122 as a physical electronic authorization device information 143, biometric identifier information 145, or mobile device authentication information 147.

In accordance with an embodiment, the service provider 122 only supports one authentication method, the one authentication method being selected from one of a user identifier (ID) and password, a physical electronic authorization device, a biometric identifier of the user, or mobile device authentication. The method further includes receiving, by the processor, the biometric identifier of the user from a biometric authenticator device, the biometric authenticator device including one or more of a sensor, a scanning device, or an electronic reader, the biometric identifier of the user being at least one physiological characteristic of the user, and wherein the at least one physiological characteristic is selected from one or more of fingerprints, palm veins, face recognition, DNA (deoxyribonucleic acid), palm print, hand geometry, iris recognition, retina, and/or odor/scent.

In accordance with an embodiment, the method 500 further includes receiving, by the processor, the access to the one or more relying party applications 124 hosted by the service provider 122 upon validation of the authentication token 214 for the user 102 by one or more of the service provider 122 or an identify provider 132.

In accordance with an embodiment, the processor is part of a multi-function peripheral, and the one or more relying party applications hosted by the service provider are print management services.

In accordance with an embodiment, the method further includes receiving, by the processor, the authentication information from the authenticator device 140 for the user 102; determining, by the processor, if the authenticator device 140 is assigned to the virtual authenticator profile for the user 102; and assigning, by the processor, the authenticator device 140 to the virtual authenticator profile for the user 102 if the authenticator devices 140 has not been previously assigned to the virtual authenticator profile for the user 102.

In accordance with an embodiment, the method further includes receiving, by the processor, the authentication information from the authenticator device 140 for the user 102; determining, by the processor, if the authenticator device 140 is assigned to a virtual authenticator 212; and creating, by the processor, the virtual authenticator 212 for the authenticator device 140 in which the virtual authenticator 212 for the authenticator device 140 has not been previously created.

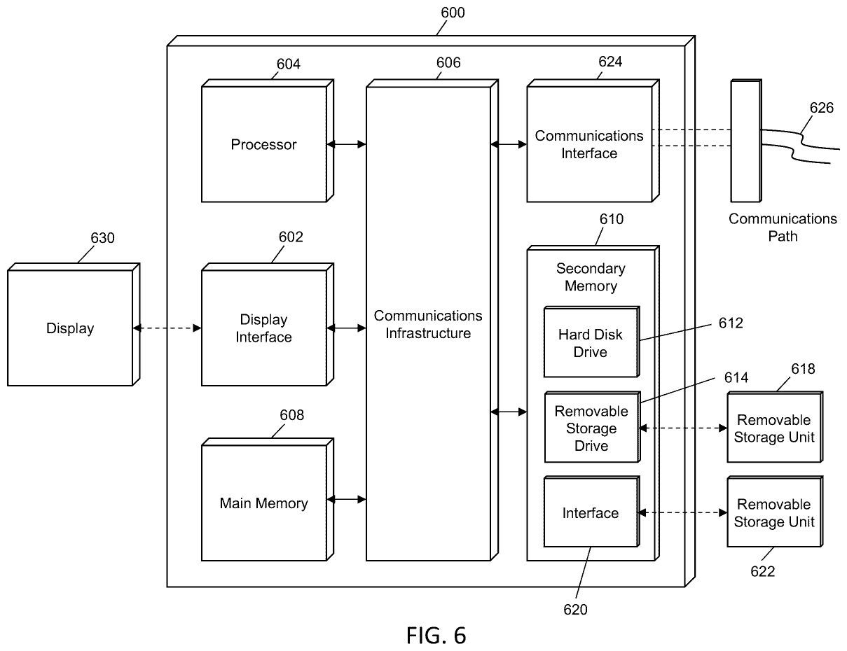

FIG. 6 illustrates a representative computer system 600 in which embodiments of the present disclosure, or portions thereof, may be implemented as computer-readable code executed on hardware. For example, the one or more computer systems 110, 120, 130, and one or more of the authenticator devices 140 associated with the method and system for generating a virtual authenticator for access to a service provider as disclosed herein may be implemented in whole or in part by a computer system 600 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this representative computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

A processor device 604 may be processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc. Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 1-5, as discussed herein.

Accordingly, such computer programs may represent controllers of the computer system 600. Where the present disclosure is implemented using software executed on hardware, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software executed on hardware, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, method, and system for generating a virtual authenticator. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generating a virtual authenticator for access to relying party applications hosted by a service provider, the method comprising:
receiving, by a processor, authentication information from an authenticator device for a user with a request for access to one or more relying party applications hosted by the service provider;
identifying, by the processor, a virtual authenticator profile for the user based on the authentication information received from the authenticator device; and
generating, by the processor, an authentication token for the user based on the virtual authenticator profile for the user and in accordance with an authentication method of the service provider.

2. The method according to claim 1, further comprising:
generating, by the processor, a virtual authenticator for the user based on the virtual authenticator profile for the user and the authentication method of the service provider; and
generating, by the processor, the authentication token for the user with the virtual authenticator.

3. The method according to claim 1, further comprising:
determining, by the processor, the authentication method for the service provider; and
sending, by the processor, the authentication token for the user in accordance with the authentication method of the service provider with the request for access to the one or more relying party applications to the service provider.

4. The method according to claim 1, further comprising:
receiving, by the processor, the authentication information from the authenticator device;
determining, by the processor, that the received authentication information from the authenticator device is a different authentication method than the authentication method of the service provider; and
generating, by the processor, the authentication token for the user in accordance with the authentication method of the service provider.

5. The method according to claim 1, further comprising:
receiving, by the processor, the authentication information from the authenticator device in a first authentication method;
determining, by the processor, that the received authentication information from the authenticator device is the authentication method of the service provider; and
generating, by the processor, the authentication token for the user in accordance with the authentication method of the service provider.

6. The method according to claim 1, further comprising:
assigning, by the processor, a plurality of physical authenticators to the user;
receiving, by the processor, one of the plurality of physical authenticators for the user from the authenticator device; and
identifying, by the processor, the virtual authenticator profile for the user based on the one of the plurality of physical authenticators for the user received from the authenticator device.

7. The method according to claim 1, further comprising:
receiving, by the processor, the authentication information from the authenticator device for the user with the request for the access to the one or more relying party applications hosted by the service provider as a physical electronic authorization device information, biometric identifier information, or mobile device authentication information.

8. The method according to claim 1, wherein the service provider only supports one authentication method, the one authentication method being selected from one of a user identifier (ID) and password, a physical electronic authorization device, a biometric identifier of the user, or mobile device authentication.

9. The method according to claim 8, further comprising:
receiving, by the processor, the biometric identifier of the user from a biometric authenticator device, the biometric authenticator device including one or more of a sensor, a scanning device, or an electronic reader, the biometric identifier of the user being at least one physiological characteristic of the user, and wherein the at least one physiological characteristic is selected from one or more of fingerprints, palm veins, face recognition, DNA (deoxyribonucleic acid), palm print, hand geometry, iris recognition, retina, and/or odor/scent.

10. The method according to claim 1, further comprising:
receiving, by the processor, the access to the one or more relying party applications hosted by the service provider upon validation of the authentication token for the user by one or more of the service provider or an identify provider.

11. The method according to claim 1, wherein the processor is part of a multi-function peripheral, and the one or more relying party applications hosted by the service provider are print management services.

12. The method according to claim 1, further comprising:
receiving, by the processor, the authentication information from the authenticator device for the user;
determining, by the processor, if the authenticator device is assigned to the virtual authenticator profile for the user; and
assigning, by the processor, the authenticator device to the virtual authenticator profile for the user if the authenticator devices has not been previously assigned to the virtual authenticator profile for the user.

13. The method according to claim 1, further comprising:
receiving, by the processor, the authentication information from the authenticator device for the user;
determining, by the processor, if the authenticator device is assigned to a virtual authenticator; and
creating, by the processor, the virtual authenticator for the authenticator device in which the virtual authenticator for the authenticator device has not been previously created.

14. A computer program product for generating a virtual authenticator for access to relying party applications hosted by a service provider, the computer program product comprising:
a non-transitory computer-readable storage medium having program instructions embodied therewith, the program instructions executable by a computer to cause the computer to perform a process, comprising:
receiving authentication information from an authenticator device for a user with a request for access to one or more relying party applications hosted by the service provider;
identifying a virtual authenticator profile for the user based on the authentication information received from the authenticator device; and
generating an authentication token for the user based on the virtual authenticator profile for the user and in accordance with an authentication method of the service provider.

15. The computer program product according to claim 14, further comprising:
generating a virtual authenticator for the user based on the virtual authenticator profile for the user and the authentication method of the service provider; and
generating the authentication token for the user with the virtual authenticator.

16. The computer program product according to claim 14, further comprising:
determining the authentication method for the service provider; and
sending the authentication token for the user in accordance with the authentication method of the service provider with the request for access to the one or more relying party applications to the service provider.

17. The computer program product according to claim 14, further comprising:
receiving the authentication information from the authenticator device;
determining that the received authentication information from the authenticator device is a different authentication method than the authentication method of the service provider; and
generating the authentication token for the user in accordance with the authentication method of the service provider.

18. A system for generating a virtual authenticator for access to relying party applications hosted by a service provider, the system comprising:
a processor configured to:
receive authentication information from an authenticator device for a user with a request for access to one or more relying party applications hosted by the service provider;
identify a virtual authenticator profile for the user based on the authentication information received from the authenticator device; and
generate an authentication token for the user based on the virtual authenticator profile for the user and in accordance with an authentication method of the service provider.

19. The system according to claim 18, wherein the processor is further configured to:
generate a virtual authenticator for the user based on the virtual authenticator profile for the user and the authentication method of the service provider; and
generate the authentication token for the user with the virtual authenticator.

20. The system according to claim 19, wherein the processor is part of a multi-function peripheral, and the one or more relying party applications hosted by the service provider are print management services.
